(19) United States
(12) Patent Application Publication
(10) Pub. No.: US 2021/0045195 A1
(43) Pub. Date: Feb. 11, 2021

(54) INFRARED RADIATION DEVICE

(71) Applicants: NGK Insulators, Ltd., Nagoya-City (JP); National University Corporation Hokkaido University, Sapporo-Shi (JP); Niigata University, Sapporo-Shi (JP)

(72) Inventors: Michiro AOKI, Nagoya-City (JP); Yoshio KONDO, Nagoya-City (JP); Tsuyoshi TOTANI, Sapporo-Shi (JP); Atsushi SAKURAI, Niigata-City (JP)

(73) Assignees: NGK Insulators, Ltd., Nagoya-City (JP); National University Corporation Hokkaido University, Sapporo-Shi (JP); Niigata University, Niigata-City (JP)

(21) Appl. No.: 17/073,700

(22) Filed: Oct. 19, 2020

Related U.S. Application Data
(63) Continuation of application No. PCT/JP2019/015890, filed on Apr. 12, 2019.

(30) Foreign Application Priority Data
Apr. 23, 2018 (JP) 2018-082171

(51) Int. Cl. H05B 3/12; H05B 3/18; H05B 3/20

(52) U.S. Cl. CPC H05B 3/12; H05B 2203/032; H05B 3/20; H05B 3/18

(57) ABSTRACT

An infrared radiation device includes a body including a heat generating part and first and second metamaterial structures that are capable of radiating infrared rays having a peak wavelength of a non-Planck distribution upon receipt of thermal energy from the heat generating part. The first metamaterial structure is disposed on a first surface side of the heat generating part, and the second metamaterial structure is disposed on a second surface side opposite to the first surface side of the heat generating part.

### BACKGROUND OF THE INVENTION

### 1. Field of the Invention

The present invention relates to an infrared radiation device.

### 2. Description of the Related Art

Conventionally, an infrared radiation device using a metamaterial structure is known. For example, Patent Literature 1 describes a radiation device that includes a heat source, a metamaterial structure layer disposed on a front-surface side of the heat source, and a rear-surface metal layer disposed on a rear-surface side of the heat source. The metamaterial structure layer radiates thermal energy input from the heat source as radiation energy in a specific wavelength region. Average emissivity of the rear-surface metal layer is set smaller than average emissivity of the metamaterial structure layer. According to Patent Literature 1, thermal energy loss from the rear-surface side of the heat source can be made small due to the rear-surface metal layer, and therefore thermal energy loss of the radiation device can be kept small.

### CITATION LIST

### Patent Literature

PTL 1: International Publication No. 2017/163986

### SUMMARY OF THE INVENTION

According to the radiation device disclosed in Patent Literature 1, thermal energy loss can be suppressed as described above, but further suppression of thermal energy loss in an infrared radiation device is desired.

The present invention was accomplished in order to solve such a problem, and a main purpose of the present invention is to further suppress energy loss of an infrared radiation device.

The present invention employs the following means in order to accomplish the above main purpose.

An infrared radiation device of the present invention includes a body including a heat generating part and first and second metamaterial structures that are capable of radiating infrared rays having a peak wavelength of a non-Planck distribution upon receipt of thermal energy from the heat generating part. The first metamaterial structure is disposed on a first surface side of the heat generating part and the second metamaterial structure is disposed on a second surface side opposite to the first surface side of the heat generating part.

This infrared radiation device includes not only a first metamaterial structure on a first surface side of a heat generating part, but also a second metamaterial structure on a second surface side opposite to the first surface side. Accordingly, infrared rays having a peak wavelength of a non-Planck distribution can be radiated from both of the first surface side and the second surface side. In other words, infrared rays in a specific wavelength region can be selectively radiated from both of the first surface side and the second surface side. Accordingly, radiation of infrared rays having an unnecessary wavelength other than the specific wavelength region from the second surface side can be suppressed as compared with a case where a rear-surface metal layer is present on a side opposite to the metamaterial structure (there is no metamaterial structure), for example, as in the radiation device described in Patent Literature 1. This reduces thermal energy loss from the second surface side. Accordingly, this infrared radiation device can further suppress energy thermal loss.

The metamaterial structure may be a structure that has radiation characteristics having a maximum peak steeper than a peak of the Planck distribution. Note that “steeper than a peak of the Planck distribution” means that “a full width at half maximum (FWHM) is narrower than the peak of the Planck distribution”.

The infrared radiation device according to the present invention may include infrared rays reflecting part that can reflect infrared rays radiated from at least one of the first and second metamaterial structures toward an object. Since the infrared rays reflecting part reflects infrared rays, energy of infrared rays radiated from the body can be easily utilized.

The infrared radiation device according to the present invention may include a casing that has infrared rays transmitting part that can transmit infrared rays radiated from the first and second metamaterial structures to an outside, and the body may be disposed in an internal space of the casing. In this case, the infrared rays reflecting part may be disposed on an inner side (e.g., an inner circumferential surface) of the casing, the infrared rays reflecting part may be disposed on an outer side (e.g., an outer circumferential surface) of the casing, or a part of the casing may also serve as the infrared rays reflecting part.

The infrared radiation device according to the present invention may be configured such that a difference between a peak wavelength of a maximum peak of infrared rays radiated by the first metamaterial structure and a peak wavelength of a maximum peak of infrared rays radiated by the second metamaterial structure is 0.5 μm or less. That is, the peak wavelength of the first metamaterial structure and the peak wavelength of the second metamaterial structure may be close to each other or may be the same as each other.

The infrared radiation device according to the present invention may be configured such that the body is exposed to an outer space or is disposed in an internal space of a casing in which the internal space is in a non-depressurized state. In other words, a space around the body may be non-depressurized atmosphere.

The infrared radiation device according to the present invention may be configured such that at least one of the first and second metamaterial structures includes, from the heat generating part side, a first conductor layer, a dielectric layer joined to the first conductor layer, and a second conductor layer having a plurality of individual conductor layers each of which is joined to the dielectric layer and that are periodically disposed away from one another.

The infrared radiation device according to the present invention may be configured such that at least one of the first and second metamaterial structures includes a plurality of microcavities that are configured such that at least a surface thereof is made of a conductor and that are periodically disposed away from one another.

### BRIEF DESCRIPTION OF THE DRAWINGS

FIG. 1 is a cross-sectional view of an infrared radiation device 10.

FIG. 2 is a cross-sectional view of the infrared radiation device 10.

FIG. 3 is a partial bottom view of a first metamaterial structure 30a.

FIG. 4 is a partial cross-sectional view of a body 11 according to a modification.

FIG. 5 is a partial bottom surface perspective view of a first metamaterial structure 30a according to the modification.

### DETAILED DESCRIPTION OF THE INVENTION

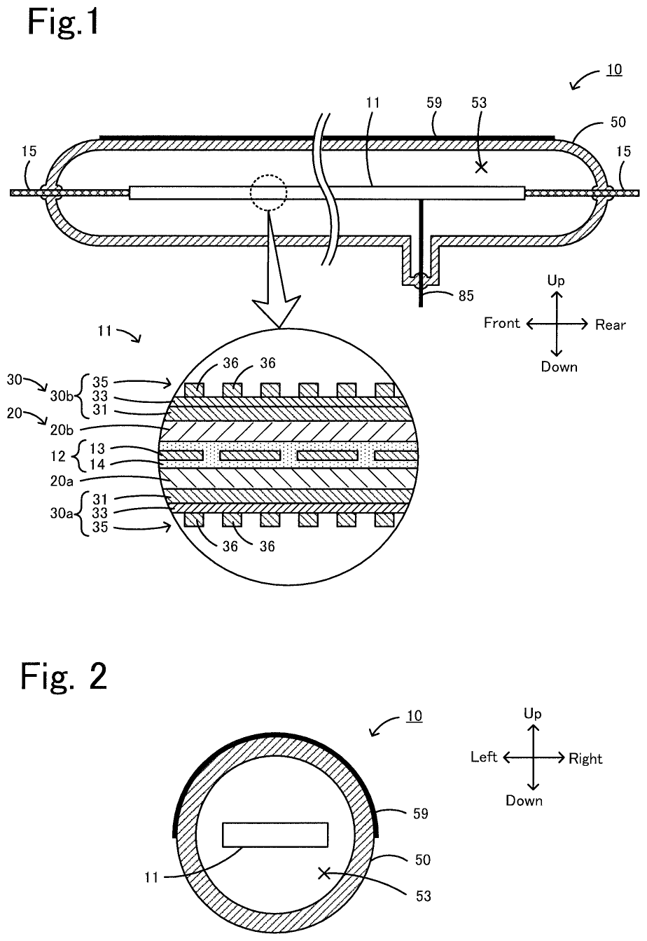

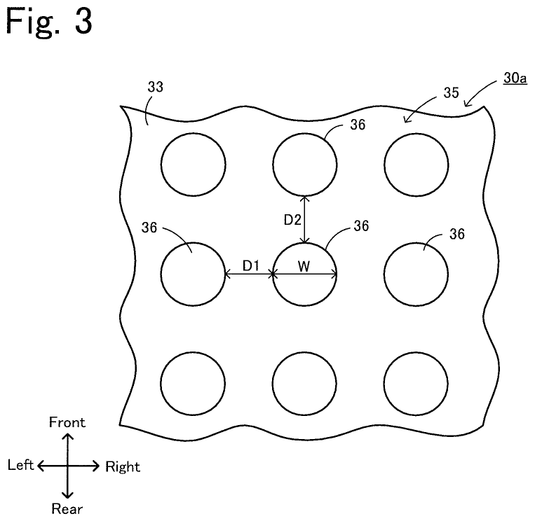

Next, an embodiment of the present invention is described by using the drawings. FIGS. 1 and 2 are cross-sectional views of an infrared radiation device 10 according to an embodiment of the present invention. FIG. 3 is a partial bottom view of a first metamaterial structure 30a. FIG. 1 is a vertical cross-sectional view taken along an axial direction (a front-rear direction in this example) of the infrared radiation device 10, and FIG. 2 illustrates a cross section perpendicular to the axial direction of the infrared radiation device 10. In the present embodiment, an up-down direction, a front-rear direction, and a left-right direction are illustrated in FIGS. 1 and 2. The infrared radiation device 10 includes a body 11, a casing 50, a reflective layer 59, and a thermocouple 85. The infrared radiation device 10 radiates infrared rays toward an object (not illustrated) disposed below the infrared radiation device 10.

The body 11 is disposed in an internal space 53 of the casing 50. The body 11 has a flat-plate shape. As illustrated in the enlarged view of FIG. 1, the body 11 includes a heat generating part 12, first and second support substrates 20a and 20b, first and second metamaterial structures 30a and 30b.

The heat generating part 12 is configured as a planar heater and includes a heat generator 13 obtained by curving a linear member in a zigzag manner and a protection member 14 that is an insulator covering the heat generator 13 in contact with the heat generator 13. The heat generator 13 is, for example, made of a material such as W, Mo, Ta, an Fe—Cr—Al alloy, or an Ni—Cr alloy. In the present embodiment, the heat generator 13 is made of Kanthal (Registered Trademark: an alloy containing iron, chromium, and aluminum). The protection member 14 is, for example, made of a material such as an insulating resin (e.g., polyimide) or ceramics. A bar-shaped conductor 15 that is conductive with the heat generator 13 is attached to both ends, in a longitudinal direction (the front-rear direction in this example), of the body 11. The bar-shaped conductor 15 is drawn out to an outside from both ends, in the axial direction, of the casing 50, and electric power can be externally supplied to the heat generator 13 through the bar-shaped conductor 15. The bar-shaped conductor 15 also plays a role as a support for the body 11 in the casing 50. In this example, the bar-shaped conductor 15 is made of Mo. The heat generating part 12 may be a planar heater obtained by winding a ribbon-shaped heat generator around an insulator.

The first and second support substrates 20a and 20b are flat-plate-shaped members. The first support substrate 20a is disposed on a first surface side (a lower surface side in this example) of the heat generating part 12. The second support substrate 20b is disposed on a second surface side (an upper surface side in this example) of the heat generating part 12. The first support substrate 20a and the second support substrate 20b are collectively referred to as support substrates 20. The support substrates 20 support the heat generating part 12 and the first and second metamaterial structures 30a and 30b. The support substrates 20 are, for example, made of a material that can easily keep a smooth surface, has high heat resistance, and has low thermal warpage such as an Si wafer or glass. In the present embodiment, the support substrates 20 are made of silica glass. The first and second support substrates 20a and 20b may be in contact with the lower surface and the upper surface of the heat generating part 12, respectively as in the present embodiment or may be disposed away from the lower surface and the upper surface of the heat generating part 12 with a space interposed therebetween. In a case where the support substrates 20 and the heat generating part 12 are in contact with each other, the support substrates 20 and the heat generating part 12 may be joined to each other.

The first and second metamaterial structures 30a and 30b are plate-shaped members. The first metamaterial structure 30a is disposed on the first surface side (the lower surface side in this example) of the heat generating part 12 and is located below the first support substrate 20a. The second metamaterial structure 30b is disposed on the second surface side (the upper surface side in this example) of the heat generating part 12 and is located above the second support substrate 20b. The first metamaterial structure 30a and the second metamaterial structure 30b are collectively referred to as metamaterial structures 30. The first metamaterial structure 30a may be directly joined to a lower surface of the first support substrate 20a or may be joined to the lower surface of the first support substrate 20a with an adhesive layer (not illustrated) interposed therebetween. Similarly, the second metamaterial structure 30b may be directly joined to an upper surface of the second support substrate 20b or may be joined to the upper surface of the second substrate 20b with an adhesive layer (not illustrated) interposed therebetween. The first metamaterial structure 30a radiates infrared rays mainly downward, and the second metamaterial structure 30b radiates infrared rays mainly upward. As illustrated in FIG. 1, the first metamaterial structure 30a and the second metamaterial structure 30b have the same constituent elements and are horizontally symmetrical to each other in the present embodiment. The first metamaterial structure 30a is described below. As for the second metamaterial structure 30b, the constituent elements are given identical reference signs in FIG. 1 and detailed description thereof is omitted.

The first metamaterial structure 30a includes a first conductor layer 31, a dielectric layer 33, and a second conductor layer 35 having a plurality of individual conductor layers 36 in this order from the heat generator 13 side toward a lower side. Such a structure is also called a metal-insulator-metal (MIM) structure. The layers of the first metamaterial structure 30a may be directly joined to one another or may be joined to one another with an adhesive layer interposed therebetween. Exposed parts of the individual conductor layers 36 and a lower surface of the dielectric layer 33 may be coated with an oxidation prevention film (not illustrated, made of alumina, for example).

The first conductor layer 31 is a flat-plate-shaped member joined on a side (a lower side) of the first support substrate 20a opposite to the heat generator 13. The first conductor layer 31 is, for example, made of a conductor (electric conductor) such as a metal. Specific examples of the metal include gold, aluminum (Al), and molybdenum (Mo). In the present embodiment, the first conductor layer 31 is made of gold. The first conductor layer 31 is joined to the first support substrate 20a with an adhesive layer (not illustrated) interposed therebetween. The adhesive layer is, for example, made of a material such as chromium (Cr), titanium (Ti), or ruthenium (Ru). The first conductor layer 31 and the first support substrate 20a may be directly joined to each other.

The dielectric layer 33 is a flat-plate-shaped member that is joined on a side (a lower side) of the first conductor layer 31 opposite to the heat generator 13. The dielectric layer 33 is sandwiched between the first conductor layer 31 and the second conductor layer 35. The dielectric layer 33 is, for example, made of alumina (Al₂O₃) or silica (SiO₂). In the present embodiment, the dielectric layer 33 is made of alumina.

The second conductor layer 35 is a layer made of a conductor and has a periodic structure in directions (the front-rear and left-right directions) parallel with a lower surface of the dielectric layer 33. Specifically, the second conductor layer 35 includes a plurality of individual conductor layers 36, and the plurality of individual conductor layers 36 are disposed away from one another in the directions (the front-rear and left-right directions) parallel with the lower surface of the dielectric layer 33 so as to constitute a periodic structure (see FIG. 3). A plurality of individual conductor layers 36 are disposed away from one another at equal intervals D1 in the left-right direction (a first direction). Furthermore, a plurality of individual conductor layers 36 are disposed away from one another at equal intervals D2 in the front-rear direction (a second direction) orthogonal to the left-right direction. In this way, the individual conductor layers 36 are arranged in a grid pattern. Although the individual conductor layers 36 are arranged in a square grid pattern in the present embodiment as illustrated in FIG. 3, the individual conductor layers 36 may be, for example, arranged in a hexagonal grid pattern so that each of the individual conductor layers 36 is located at a vertex of an equilateral triangle. Each of the plurality of individual conductor layers 36 has a circular shape on bottom view and has a shape of a circular column having a thickness h (a height in the up-down direction) smaller than a diameter W. A cycle of the periodic structure of the second conductor layer 35 is Λ1=D1+W in the lateral direction and is Λ2=D2+W in the vertical direction. In the present embodiment, D1=D2, and Λ1=Λ2 accordingly. A material of the second conductor layer 35 (the individual conductor layers 36) is, for example, a conductor such as a metal and may be similar to the material of the first conductor layer 31. At least one of the first conductor layer 31 and the second conductor layer 35 may be a metal. In the present embodiment, the second conductor layer 35 is made of gold, which is the same as the material of the first conductor layer 31.

As described above, the first metamaterial structure 30a has the first conductor layer 31, the second conductor layer 35 (the individual conductor layers 36) having a periodic structure, and the dielectric layer 33 sandwiched between the first conductor layer 31 and the second conductor layer 35. With this configuration, the first metamaterial structure 30a can radiate infrared rays having a peak wavelength of a non-Planck distribution upon receipt of thermal energy from the heat generating part 12. The Planck distribution is a mound-shaped distribution having a specific peak on a graph whose horizontal axis represents a wavelength that becomes longer toward the right and whose vertical axis represents an irradiance intensity and is a curve whose gradient on a left side of the peak is steep and whose gradient on a right side of the peak is gradual. Radiation of a typical material complies with this curve (a Planck radiation curve). Non-Planck radiation (radiation of infrared rays having a peak wavelength of a non-Planck distribution) is radiation such that a gradient of a mound shape around a maximum peak of the radiation is steeper than the Planck radiation. That is, the first metamaterial structure 30a has radiation characteristics having a maximum peak steeper than a peak of the Planck distribution. Note that “steeper than a peak of the Planck distribution” means that “a full width at half maximum (FWHM) is narrower than the peak of the Planck distribution”. With this configuration, the first metamaterial structure 30a functions as a metamaterial emitter having characteristics of selectively radiating infrared rays of a specific wavelength in an entire wavelength region (0.7 μm to 1000 μm) of infrared rays. The characteristics are considered to be exhibited due to a resonance phenomenon explained as magnetic polariton. The magnetic polariton is a resonance phenomenon in which an anti-parallel current is excited in two upper and lower conductors (the first conductor layer 31 and the second conductor layer 35) and a strong magnetic confinement effect is obtained in a dielectric body (the dielectric layer 33) disposed between the two upper and lower conductors. For this reason, in the first metamaterial structure 30a, locally strong electric field oscillation is excited in the first conductor layer 31 and the individual conductor layers 36, which serve as an infrared radiation source, and thus infrared rays are radiated to a surrounding environment (especially downward in this example). Furthermore, in this first metamaterial structure 30a, a resonance wavelength can be adjusted by adjusting the materials which the first conductor layer 31, the dielectric layer 33, and the second conductor layer 35 are made of and a shape and a periodic structure of the individual conductor layers 36. With this configuration, infrared rays radiated from the first conductor layer 31 and the individual conductor layers 36 of the first metamaterial structure 30a exhibits characteristics such that emissivity of infrared rays of a specific wavelength is high. That is, the first metamaterial structure 30a has characteristics for radiating infrared rays having a steep maximum peak having a relatively small full width at half maximum and relatively high emissivity. Although D1=D2 in the present embodiment, the interval D1 and the interval D2 may be different from each other. This also applies to the cycle Λ1 and the cycle Λ2. Note that the full width at half maximum can be controlled by changing the cycle Λ1 and the cycle Λ2. The maximum peak of the predetermined radiation characteristics of the first metamaterial structure 30a may be within a wavelength range of not less than 6 μm to not more than 7 μm or may be within a wavelength range of not less than 2.5 μm to not more than 3.5 μm. Furthermore, the first metamaterial structure 30a is preferably configured such that emissivity of infrared rays in a wavelength region other than a wavelength region from rising to falling of the maximum peak is 0.2 or less. The first metamaterial structure 30a is preferably configured that the full width at half maximum of the maximum peak is 1.0 μm or less. The radiation characteristics of the first metamaterial structure 30a may have a shape substantially vertically symmetrical about the maximum peak. Furthermore, a height (a maximum irradiance intensity) of the maximum peak of the first metamaterial structure 30a does not exceed the curve of Planck radiation.

The first metamaterial structure 30a described above can be formed, for example, as follows. First, the adhesive layer and the first conductor layer 31 are formed in this order on a surface (a lower surface in FIG. 1) of the first support substrate 20a by sputtering. Next, the dielectric layer 33 is formed on a surface (a lower surface in FIG. 1) of the first conductor layer 31 by atomic layer deposition (ALD). Next, a layer made of the material of the second conductor layer 35 is formed on a surface (a lower surface in FIG. 1) of the dielectric layer 33 by helicon sputtering after a predetermined resist pattern is formed on the surface of the dielectric layer 33. Then, the second conductor layer 35 (the plurality of individual conductor layers 36) is formed by removing the resist pattern.

The infrared radiation characteristics of the first metamaterial structure 30a and the infrared radiation characteristics of the second metamaterial structure 30b may be close to each other or may be the same as each other. For example, a maximum peak of infrared rays radiated by the second metamaterial structure 30b may be the same as or close to the maximum peak of infrared rays radiated by the first metamaterial structure 30a. Specifically, a difference between a peak wavelength of the maximum peak of infrared rays radiated by the first metamaterial structure 30a and a peak wavelength of the maximum peak of infrared rays radiated by the second metamaterial structure 30b may be 0.5 μm or less. Furthermore, at least part of a wavelength region of a full width at half maximum (a full width at half maximum region) of the maximum peak of the first metamaterial structure 30a and at least part of a wavelength region of a full width at half maximum (a full width at half maximum region) of the maximum peak of the second metamaterial structure 30b may overlap each other or a half or more of the wavelength region of the full width at half maximum (a full width at half maximum region) of the maximum peak of the first metamaterial structure 30a and a half or more of the wavelength region of the full width at half maximum (a full width at half maximum region) of the maximum peak of the second metamaterial structure 30b may overlap each other. In the present embodiment, the first and second metamaterial structures 30a and 30b have the same D1, D2, and W and have almost the same infrared radiation characteristics.

The thermocouple 85 is an example of a temperature sensor that measures a temperature of a surface of the body 11 and is drawn out to an outside from the surface of the body 11 by penetrating the casing 50.

The casing 50 is a substantially cylindrical member. The casing 50 has an internal space 53 therein. In the internal space 53, the body 11 is disposed. The whole casing 50 functions as infrared rays transmitting part that can transmit, to an outside, infrared rays radiated from the first and second metamaterial structures 30a and 30b. The casing 50 can transmit infrared rays in at least part of the wavelength region from rising to falling of the maximum peak of infrared rays radiated from the first metamaterial structure 30a and can transmit infrared rays in at least part of the wavelength region from rising to falling of the maximum peak of infrared rays radiated from the second metamaterial structure 30b. The casing 50 preferably can transmit at least a wavelength region including the maximum peaks of infrared rays radiated from the first and second metamaterial structures 30a and 30b, more preferably can transmit at least a wavelength region including the full width at half maximum regions of the maximum peaks of the infrared rays radiated from the first and second metamaterial structures 30a and 30b. The casing 50 may have transmittance of 80% or more or may have transmittance or 90% or more as for infrared rays having peak wavelengths of the maximum peaks radiated from the first and second metamaterial structures 30a and 30b. The casing 50 is, for example, made of infrared rays transmitting material such as silica glass (which transmits infrared rays having a wavelength of not more than 3.5 μm), transparent alumina (which transmits infrared rays having a wavelength of not more than 5.5 μm), or fluorite (calcium fluoride, CaF₂, which transmits infrared rays having a wavelength of not more than 8 μm). The material of the casing 50 may be selected as appropriate, for example, in accordance with the maximum peaks of infrared rays radiated from the metamaterial structures 30. In the present embodiment, the casing 50 is made of silica glass. The internal space 53 is in a non-depressurized state. The internal space 53 may be an air atmosphere or may be an inert gas atmosphere such as nitrogen or argon. Both ends, in the axial direction, of the casing 50 have a curved taper shape, and the bar-shaped conductor 15 is drawn out to an outside from these ends. Parts of the casing 50 where the bar-shaped conductor 15 and the thermocouple 85 are drawn out to an outside from the internal space 53 are sealed by providing molten parts obtained by melting the casing 50. These parts may be sealed by using a sealing member different from the casing 50.

In the present embodiment, the radiation characteristics of the first and second metamaterial structures 30a and 30b are set so that the peak wavelength of the maximum peak is 3.0 μm since the casing 50 is made of silica glass, which transmits infrared rays having a wavelength of not more than 3.5 μm (absorbs infrared rays of more than 3.5 μm). These radiation characteristics can be realized, for example, by setting the thickness of the first conductor layer 31 to 100 nm, setting the thickness of the dielectric layer 33 to 80 nm, setting the thickness of the second conductor layer 35 (the individual conductor layers 36) to 60 nm, setting the diameter W of the individual conductor layers 36 to 0.565 μm, and setting the cycles Λ1 and Λ2 to 4 μm.

The reflective layer 59 is an example of infrared rays reflecting part and is disposed so as to cover a part of an outer circumferential surface of the casing 50. Accordingly, the reflective layer 59 is provided so as to cover only part of surroundings of the body 11. The reflective layer 59 is disposed in a direction perpendicular to a longitudinal direction of the casing 50 when viewed from the body 11 (above the body 11 in this example). The reflective layer 59 is disposed on a side (an upper side in this example) of the second metamaterial structure 30b opposite to the heat generating part 12. The reflective layer 59 is disposed on an outer upper surface of the casing 50. In this example, it is assumed that the reflective layer 59 covers all of an upper half of the outer circumferential surface of the casing 50 (see FIG. 2). The reflective layer 59 has an arc shape (in particular, a semi-circular shape in this example) on a cross-sectional view perpendicular to the longitudinal direction of the infrared radiation device 10 as illustrated in FIG. 2. The reflective layer 59 is disposed so as to face the second metamaterial structure 30b and is located in a direction (an upward direction in this example) of main infrared radiation from the second metamaterial structure 30b. The reflective layer 59 reflects downward infrared rays radiated from the second metamaterial structure 30b. The reflective layer 59 is, for example, made of a material such as gold, platinum, or aluminum. In this example, the reflective layer 59 is made of gold. The reflective layer 59 may be formed on a surface of the casing 50 by using a film formation method such as coating and drying, sputtering, CVD, or thermal spraying.

An example of use of the infrared radiation device 10 described above is described below. First, electric power is supplied from a power source (not illustrated) to the heat generator 13 through the bar-shaped conductor 15. The electric power is supplied so that a temperature of the heat generator 13 reaches a preset temperature (not limited in particular but is set to 320° C. in this example). Energy is transmitted to surroundings from the heat generator 13 that has reached the predetermined temperature mainly through conduction among three forms of heat transmission (conduction, convection, and radiation), and thus the metamaterial structures 30 are heated. As a result, a temperature of the metamaterial structures 30 rises to a predetermined temperature (for example, 300° C. in this example), and the metamaterial structures 30 serve as radiators that radiate infrared rays. Since the metamaterial structures 30 have the first conductor layer 31, the dielectric layer 33, and the second conductor layer 35 as described above, the body 11 radiates infrared rays having a peak wavelength of a non-Planck distribution. More specifically, the body 11 selectively radiates infrared rays in a specific wavelength region from the first conductor layer 31 and the individual conductor layers 36 of the metamaterial structures 30. The infrared rays in the specific wavelength region radiated from the first metamaterial structure 30a passes through the casing 50 and is radiated to a region below the infrared radiation device 10. Furthermore, infrared rays in the specific wavelength region radiated mainly upward from the second metamaterial structure 30b is reflected downward by the reflective layer 59 and is radiated to a region below the infrared radiation device 10. This allows the infrared radiation device 10 to selectively radiate infrared rays in the specific wavelength region from the first and second metamaterial structures 30a and 30b to an object disposed below the infrared radiation device 10. It is therefore possible to perform infrared processing such as heating process, drying processing, or chemical reaction, for example, on an object having a high rate of absorption of infrared rays in the specific wavelength region by efficiently radiating the infrared rays toward the object.

The infrared radiation device 10 according to the present embodiment described in detail above includes not only the first metamaterial structure 30a on a first surface side (a lower surface side) of the heat generating part 12, but also the second metamaterial structure 30b on a second surface side (an upper surface side) opposite to the first surface side. Accordingly, infrared rays having a peak wavelength of a non-Planck distribution can be radiated from both of the first surface side and the second surface side of the heat generating part 12. In other words, infrared rays in a specific wavelength region can be selectively radiated from both of the first surface side and the second surface side of the heat generating part 12. Accordingly, for example, radiation of infrared rays having an unnecessary wavelength other than the specific wavelength region from the second surface side of the heat generating part 12 can be suppressed as compared with a case where the second metamaterial structure 30b is not present or a case where the rear-surface metal layer described in Patent Literature 1 is present instead of the second metamaterial structure 30b. This reduces thermal energy loss from the second surface side. Accordingly, the infrared radiation device 10 can further suppress energy thermal loss.

Furthermore, the infrared radiation device 10 includes the reflective layer 59 that can reflect infrared rays radiated from the second metamaterial structure 30b toward an object. This makes it easy to use energy of the second metamaterial structure 30b radiated from the body 11. For example, in the present embodiment, the reflective layer 59 is located above the second metamaterial structure 30b, and the reflective layer 59 reflects downward infrared rays radiated upward from the second metamaterial structure 30b. With this configuration, energy of infrared rays radiated from the second metamaterial structure 30b can be used for infrared processing of an object even in a case where there is no object irradiated with infrared rays on the second surface side of the body 11 (an upper side of the body 11 in this example).

The present invention is not limited to the above-described embodiments, and can be carried out by various modes as long as they belong to the technical scope of the invention.

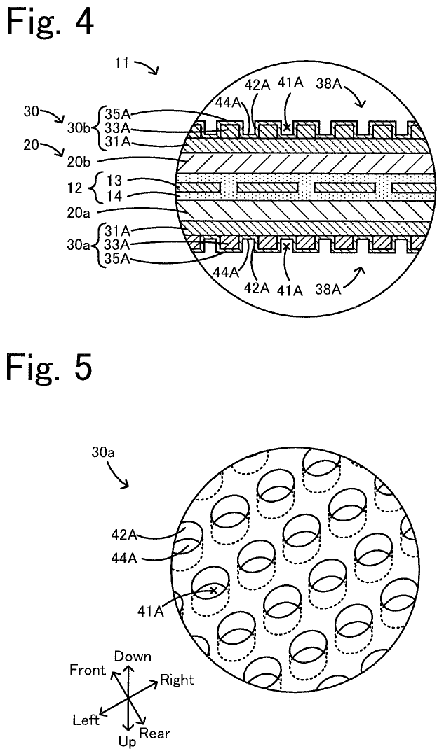

For example, although each of the metamaterial structures 30 has the first conductor layer 31, the dielectric layer 33, and the second conductor layer 35, i.e., an MIM structure in the above embodiment, this configuration is not restrictive. The metamaterial structures 30 may be any structures that can radiate infrared rays having a peak wavelength of a non-Planck distribution upon receipt of thermal energy from the heat generating part 12. For example, the metamaterial structures may be configured as microcavity structures each having a plurality of microcavities. FIG. 4 is a partial cross-sectional view of a body 11 according to a modification. FIG. 5 is a partial bottom perspective view of a first metamaterial structure 30a according to the modification. Each of the first and second metamaterial structures 30a and 30b of the body 11 according to the modification has a plurality of microcavities 41A that are configured such that at least surfaces (side surfaces 42A and bottom surfaces 44A in this example) thereof are a conductor layer 35A and that constitute a periodic structure in the front-rear and left-right directions. The first metamaterial structure 30a and the second metamaterial structure 30b have the same constituent elements and are horizontally symmetrical to each other. The following describes the first metamaterial structure 30a in detail. As for the second metamaterial structure 30b, the constituent elements are given identical reference signs in FIG. 4 and detailed description thereof is omitted. The first metamaterial structure 30a includes a body layer 31A, a recess formation layer 33A, and a conductor layer 35A in this order from a heat generating part 12 side of the body 11 toward a lower side. The body layer 31A is, for example, a glass substrate. The recess formation layer 33A is, for example, made of a resin or an inorganic material such as ceramics or glass and is formed on a lower surface of the body layer 31A so as to form recesses each having a shape of a circular column. The recess formation layer 33A may be made of the same material as the second conductor layer 35. The conductor layer 35A is disposed on a surface (a lower surface) of the first metamaterial structure 30a and covers surfaces (a lower surface and side surfaces) of the recess formation layer 33A and a lower surface of the body layer 31A (a part where the recess formation layer 33A is not disposed). The conductor layer 35A is a conductor and is, for example, made of a material such as a metal (e.g., gold or nickel) or an electrically conductive resin. Each of the microcavities 41A is a substantially circular columnar space that is surrounded by a side surface 42A (a part that covers the side surface of the recess formation layer 33A) and a bottom surface 44A (a part that covers the lower surface of the body layer 31A) of the conductor layer 35A and is opened on a lower side. As illustrated in FIG. 5, the plurality of microcavities 41A are arranged in the front-rear and left-right directions. Note that the lower surface of the first metamaterial structure 30a serves as a radiation surface 38A that radiates infrared rays toward an object. Specifically, when the first metamaterial structure 30a absorbs energy from the heat generating part 12, infrared rays having a specific wavelength is strongly radiated from the radiation surface 38A toward an object below the first metamaterial structure 30a due to a resonance effect between an incident wave and a reflected wave in the space formed by the bottom surface 44A and the side surface 42A. With this configuration, the first metamaterial structure 30a can radiate infrared rays having a peak wavelength of a non-Planck distribution. Note that radiation characteristics of the first metamaterial structure 30a can be adjusted by adjusting a diameter and a depth of a circular column of each of the plurality of microcavities 41A. Note that the shape of each of the microcavities 41A is not limited to a circular column and may be a polygonal column. The depth of each of the microcavities 41A may be, for example, not less than 1.5 μm and not more than 10 μm. Since an infrared radiation device that has the body 11 illustrated in FIGS. 4 and 5 is also configured such that the body 11 includes the first and second metamaterial structures 30a and 30b as in the above embodiment, thermal energy loss from the second surface side of the body 11 is reduced. The first metamaterial structure 30a illustrated in FIGS. 4 and 5 can be formed, for example, as follows. First, the recess formation layer 33A is formed the lower surface of the body layer 31A by known nanoimprint. Then, the conductor layer 35A is formed, for example, by sputtering so as to cover a surface of the recess formation layer 33A and a surface of the body layer 31A. It is also possible to employ a configuration in which one of the first and second metamaterial structures 30a and 30b has an MIM structure and the other one of the first and second metamaterial structures 30a and 30b has microcavities.

Although the reflective layer 59 is disposed on an outer circumferential surface of the casing 50 in the above embodiment, the reflective layer 59 may be disposed at a position on an outer side of the casing 50 other than the outer circumferential surface. For example, infrared rays reflecting part that is an independent member may be disposed on an outer side of the casing 50 instead of the reflective layer 59. Alternatively, the reflective layer 59 may be disposed on an inner side (e.g., an inner circumferential surface) of the casing 50. Furthermore, a part of the casing 50 may also serve as infrared rays reflecting part instead of the configuration in which the infrared radiation device 10 includes the reflective layer 59. In this case, the casing 50 need just have infrared rays transmitting part and infrared rays reflecting part instead of the configuration in which the whole casing 50 functions as infrared rays transmitting part as in the above embodiment. For example, the casing 50 may include a casing body that functions as infrared rays reflecting part and infrared rays transmitting plate that plays a role as a window that transmits infrared rays radiated from the metamaterial structures 30 to an outside of the casing 50. The infrared rays transmitting plate is, for example, disposed so as to face the lower surface of the first metamaterial structure 30a. In this case, the casing body is, for example, made of a material such as stainless steel. The infrared rays transmitting plate is, for example, made of the aforementioned infrared rays transmitting material. The casing 50 need not entirely be infrared rays transmitting part and need just include at least infrared rays transmitting part irrespective of whether or not the casing 50 includes infrared rays reflecting part.

The reflective layer 59 has an arc shape (in particular, a semi-circular shape in this example) on a cross-sectional view as illustrated in FIG. 2 but is not limited to this. For example, the reflective layer 59 may be a hemisphere shape or may be a flat-plate shape.

Although the reflective layer 59 is disposed on a side (an upper side in this example) of the second metamaterial structure 30b opposite to the heat generating part 12, this configuration is not restrictive. The infrared rays reflecting part provided in the infrared radiation device 10 need just reflect infrared rays radiated from at least one of the first metamaterial structure 30a and the second metamaterial structure 30b toward an object. Furthermore, although the reflective layer 59 reflects downward infrared rays radiated from the second metamaterial structure 30b, a direction in which the infrared rays are reflected is not limited to this. For example, the infrared radiation device 10 may include a reflective layer 59 located on at least one of left and right sides of the casing 50 in FIG. 2 instead of the reflective layer 59 of FIG. 2. The reflective layer 59 in this case may reflect downward infrared rays radiated from the first metamaterial structure 30a and reflect upward infrared rays radiated from the second metamaterial structure 30b.

Although the reflective layer 59 reflects infrared rays toward an object in the above embodiment, the reflective layer 59 may reflect part of the infrared rays toward the body 11. Note, however, that the reflective layer 59 preferably reflect infrared rays toward the object as much as possible.

In the above embodiment, the infrared radiation device 10 need not include the reflective layer 59. Even in a case where the infrared rays reflecting part such as the reflective layer 59 is not present, energy of infrared rays radiated from the first and second metamaterial structures 30a and 30b can be utilized in a case where an object is present above and below the infrared radiation device 10. In this case, the object below the infrared radiation device 10 and the object above the infrared radiation device 10 may be different, and the first and second metamaterial structures 30a and 30b may have different radiation characteristics in accordance with the respective objects.

Although the internal space 53 of the casing 50 is in a non-depressurized state in the above embodiment, this configuration is not restrictive, and the internal space 53 of the casing 50 may be in a depressurized state or may be in a vacuum state. Furthermore, the infrared radiation device 10 need not include the casing 50, and the body 11 may be exposed to an outer space. Even in this case, a space (an outer space) around the body 11 may be in a non-depressurized state such as atmosphere.

The present application claims priority from Japanese Patent Application No. 2018-082171 filed Apr. 23, 2018, the entire contents of which are incorporated herein by reference.

What is claimed is:

1. An infrared radiation device comprising a body including a heat generating part and first and second metamaterial structures that are capable of radiating infrared rays having a peak wavelength of a non-Planck distribution upon receipt of thermal energy from the heat generating part,
wherein the first metamaterial structure is disposed on a first surface side of the heat generating part and the second metamaterial structure is disposed on a second surface side opposite to the first surface side of the heat generating part.

2. The infrared radiation device according to claim 1, further comprising infrared rays reflecting part that is capable of reflecting infrared rays radiated from at least one of the first and second metamaterial structures toward an object.

3. The infrared radiation device according to claim 1, further comprising a casing that has infrared rays transmitting part that is capable of transmitting infrared rays radiated from the first and second metamaterial structures to an outside,
wherein the body is disposed in an internal space of the casing.

4. The infrared radiation device according to claim 1, wherein a difference between a peak wavelength of a maximum peak of infrared rays radiated from the first metamaterial structure and a peak wavelength of a maximum peak of infrared rays radiated from the second metamaterial structure is 0.5 μm or less.

5. The infrared radiation device according to claim 1,
wherein the body is exposed to an outer space or is disposed in an internal space of a casing in which the internal space is in a non-depressurized state.

6. The infrared radiation device according to claim 1,
wherein at least one of the first and second metamaterial structures includes, from the heat generating part side, a first conductor layer, a dielectric layer joined to the first conductor layer, and a second conductor layer having a plurality of individual conductor layers each of which is joined to the dielectric layer and that are periodically disposed away from one another.

7. The infrared radiation device according to claim 1,
wherein at least one of the first and second metamaterial structures includes a plurality of microcavities that are configured such that at least a surface thereof is made of a conductor and that are periodically disposed away from one another.
